(19) United States
(12) Patent Application Publication
(10) Pub. No.: US 2023/0401642 A1
(43) Pub. Date: Dec. 14, 2023

(54) Incentivized Rental Vehicle Return

(71) Applicant: AT&T Intellectual Property I, L.P, Atlanta, GA (US)

(72) Inventors: Wasib Khallil, Lilburn, GA (US); Iftekhar Alam, Roswell, GA (US); Bhumit Patel, Smyrna, GA (US); Jonathan Chang, Atlanta, GA (US)

(73) Assignee: AT&T Intellectual Property I, L.P., Atlanta, GA (US)

(21) Appl. No.: 17/838,525

(22) Filed: Jun. 13, 2022

(51) Int. Cl. G06Q 40/06; G06Q 30/02; G06Q 30/06; G06N 20/00

(52) U.S. Cl. CPC G06Q 40/06; G06Q 30/0207; G06Q 30/0645; G06N 20/00

(57) ABSTRACT

The concepts and technologies disclosed herein are directed to incentivized rental vehicle return. According to one aspect disclosed herein, a user device can determine a return location and a return date for a rental vehicle that is subject to an existing vehicle rental agreement between a user and a rental company. The user device can calculate a return on investment (“ROI”) for the return location and the return date in consideration of an incentive to be provided to the user, compare the ROI to an initial ROI based on the existing vehicle rental agreement, and determine whether the ROI is greater than the initial ROI. The user device also can present, to the user, a return option that identifies the return location, the return date, and the incentive when the ROI is greater than the initial ROI.

### BACKGROUND

Vehicles such as cars, trucks, vans, motorcycles, and mopeds can be rented, typically for a fee (e.g., per day or per week), and subject to conditions of a rental agreement (e.g., mileage limit, pick-up location, return/drop-off location, duration, etc.). Individuals and companies (referred to generally as “users”) may rent vehicles as a convenient way to travel, to transport large items such as furniture, to experience a new vehicle, or to provide transportation while their vehicle is being repaired, among other beneficial use cases. Typically, the cost of rental vehicles is affected by demand peaks due to events or seasonal changes. In recent years, the cost has been further increased by supply chain shortages due to COVID-19. A side effect of the supply chain shortages is longer service life for rental vehicles, which increases maintenance costs that are passed on to the user and greatly reduces rental vehicle reliability.

### SUMMARY

Concepts and technologies disclosed herein are directed to incentivized rental vehicle return. According to one aspect of the concepts and technologies disclosed herein, a user device can include a processor and a memory. The memory can have computer-executable instructions stored thereon that, when executed by the processor, cause the processor to perform operations. In particular, the user device can calculate a return location and a return date for a rental vehicle. The rental vehicle can be subject to an existing vehicle rental agreement between a user and a rental company. The user device can calculate a return on investment (“ROI”) for the return location and the return date in consideration of an incentive to be provided to the user, comparing the ROI to an initial ROI based on the existing vehicle rental agreement, and determining whether the ROI is greater than the initial ROI. If the ROI is greater than the initial ROI, the user device can present, to the user, a return option that identifies the return location, the return date, and the incentive. The user device can receive a selection of the return option that identifies the return location, the return date, and the incentive. The existing vehicle rental agreement can be updated to reflect the selection of the return option, thereby creating an updated vehicle rental agreement between the user and the rental company.

In some embodiments, the user device can notify the user of the incentive upon the user satisfying the updated vehicle rental agreement. The incentive can be or can include a future rental credit, a future rental upgrade (e.g., compact to mid-size vehicle upgrade or standard to premium vehicle upgrade), a coupon, or a monetary compensation. In some embodiments, the incentive is based, at least in part, upon how far the return location is from a current location of the user, a current demand for the rental vehicle, a rental rate on the return date, and the initial return on investment.

In some embodiments, the user device can calculate the return location and the return date for the rental vehicle by utilizing a machine learning algorithm. The user device may execute the machine learning algorithm locally. Alternatively, the user device can coordinate with a remote machine learning system regarding the execution of the machine learning algorithm to calculate the return location and the return date for the rental vehicle.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating aspects of an illustrative operating environment for various concepts disclosed herein.

FIGS. 2A-2B are flow diagrams illustrating aspects of a method for incentivizing rental vehicle return, according to an illustrative embodiments of the concepts and technologies disclosed herein.

FIG. 3 is a flow diagram illustrating aspects of a method for incentivizing rental vehicle repair or maintenance, according to an illustrative embodiments of the concepts and technologies disclosed herein.

FIGS. 4A-4C are graphical user interface (“GUI”) diagrams illustrating aspects exemplary user interfaces, according to an illustrative embodiment of the concepts and technologies disclosed herein.

FIG. 5 is a block diagram illustrating an example computer system capable of implementing aspects of the embodiments presented herein.

FIG. 6 is a block diagram illustrating an example mobile device capable of implementing aspects of the embodiments disclosed herein.

FIG. 7 is a diagram illustrating a network, according to an illustrative embodiment.

FIG. 8 is a diagram illustrating an illustrative machine learning system capable of implementing aspects of the concept and technologies disclosed herein.

### DETAILED DESCRIPTION

The aforementioned shortcomings of current rental vehicle user experiences can be addressed, at least in part, by the concepts and technologies disclosed herein. In particular, the concepts and technologies disclosed herein provide a vehicle rental application that utilizes a machine learning algorithm (locally or remotely executed) to propose users with various return locations, return dates, and if applicable, repair options, in exchange for credits and/or other incentives. This novel solution can help rental car companies improve the quality of service and increase revenue by making the rental vehicles safer, cheaper, and more accessible to more people.

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, vehicles, wireless devices, multiprocessor systems, distributed computing systems, microprocessor-based or programmable consumer electronics, minicomputers, mainframe computers, routers, switches, other computing devices described herein, and the like.

In the following detailed description, references are made to the accompanying drawings that form a part hereof, and in which are shown by way of illustration specific embodiments or examples. Referring now to the drawings, in which like numerals represent like elements throughout the several figures, aspects of incentivized rental vehicle return will be described.

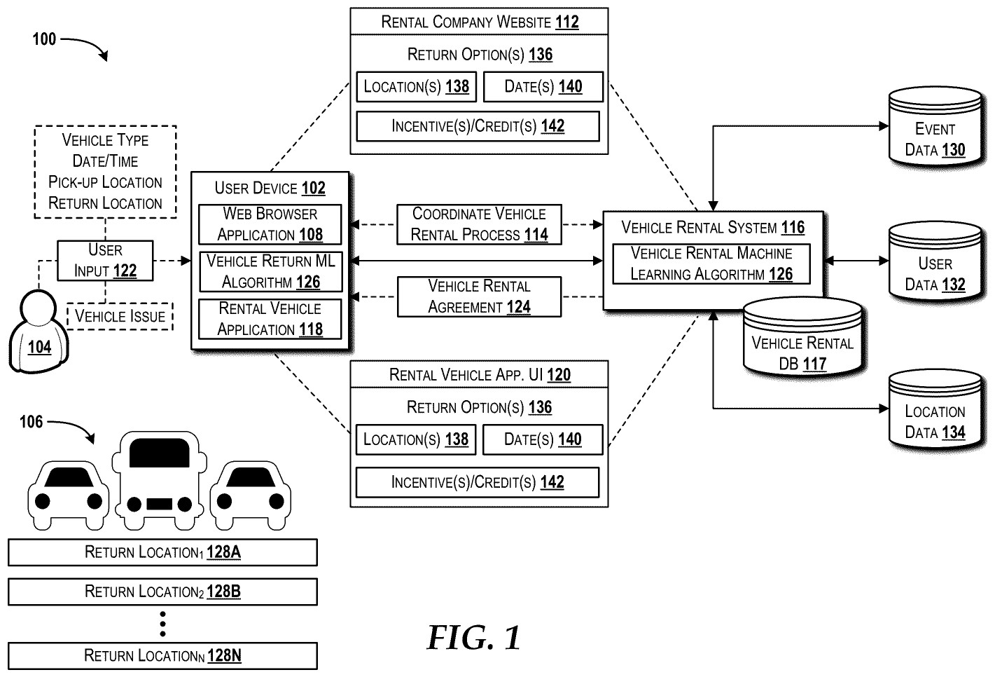

Referring now to FIG. 1, aspects of an illustrative operating environment 100 for various concepts disclosed herein will be described. It should be understood that the operating environment 100 and the various components thereof have been greatly simplified for purposes of discussion. Accordingly, additional or alternative components of the operating environment 100 can be made available without departing from the embodiments described herein.

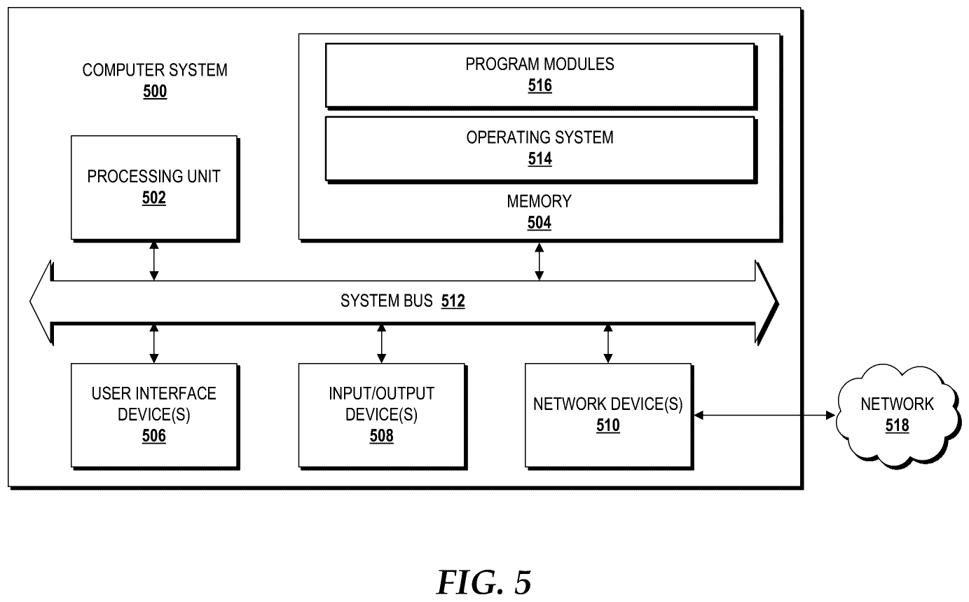

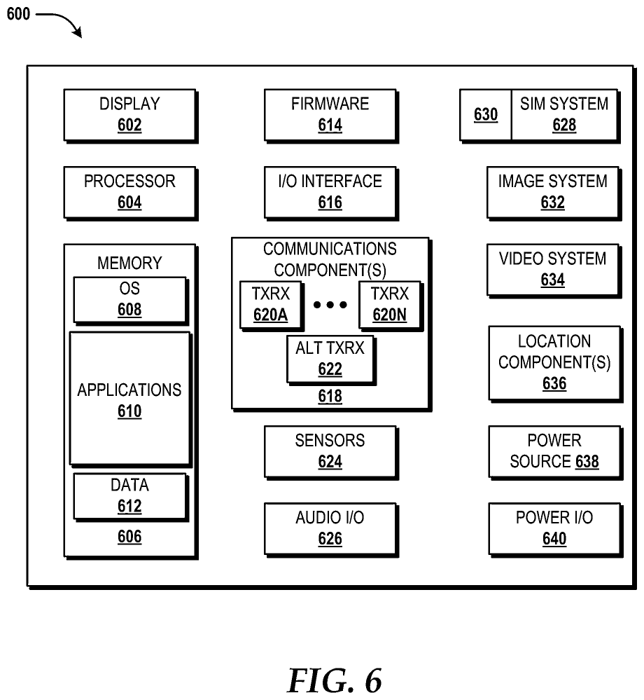

The illustrated operating environment 100 includes a user device 102 associated with a user 104 who desires to rent a vehicle 106 (hereafter “rental vehicle 106”) from a rental company. The user device 102 may be any computing device capable of executing, via one or more processors, a web browser application 108 and/or a rental vehicle application 118 in accordance with the concepts and technologies disclosed herein. For example, the user device 102 may be a computer system such as a laptop or desktop computer (best shown in FIG. 5), or a mobile device such as a smartphone or tablet (best shown in FIG. 6). Other devices such as smart watches and other wearable devices are also contemplated as embodiments of the user device 102. The user 104 may be an individual, group of individuals, or a company. The user 104 will be referred to herein as an individual for ease of explanation and not limitation.

The user device 102 can launch the web browser application 108, which can access a rental company website 112 through which the user 104 can coordinate a vehicle rental with a vehicle rental system 116 (shown generally as “coordinate vehicle rental process 114”). Alternatively, the user device 102 can launch the rental vehicle application 118, which can provide a rental vehicle application user interface 120 through which the user 104 can participate in the coordinate vehicle rental process 114. The functionality of the rental company website 112 and the rental vehicle application 118 can be the same as illustrated and described herein, although either may provide additional and/or alternative functionality. The rental company website 112 can be accessed at a uniform resource locator (“URL”) via the web browser application 108. The rental company website 112 may require login credentials such as username and password. The user 104 may create a user account with the rental company to enable secure access to the rental company website 112, and similarly to login and use the rental vehicle application 118. The rental vehicle application user interface 120 can be accessed natively on the user device 102 via the rental vehicle application 118. The web browser application 108 and the rental vehicle application 118 may be downloaded to and installed on the user device 102 (e.g., via an application marketplace/store), although either or both may be pre-installed (e.g., factory installed) on the user device 102.

The user 104 can provide user input 122 to the user device 102. The user input 122 can be keyboard, mouse, touchscreen, voice, other input, or some combination thereof. The user input 122 can include navigating the rental company website 112 and/or the rental vehicle application user interface 120. For purposes of the concepts and technologies disclosed herein, the user input 122 will be described as including, but not limited to, input corresponding to a selection of a vehicle type (e.g., car, truck, van, motorcycle, moped, or the like), a date and time for vehicle pick-up, a date and time for vehicle drop-off, a pick-up location, and a return location. It should be understood that the user input 122 can be provided as part of the coordinate vehicle rental process 114. More particularly, the coordinate vehicle rental process 114 can include the user 104 providing one or more search terms (as the user input 122) to search for the vehicle type(s), the date(s)/time(s) available for pick-up and return, and the location(s) available for pick-up and return. The vehicle rental system 116 can consult a vehicle rental database 117 to determine the available vehicle type(s), the date(s)/time(s) available for pick-up and return, and the location(s) available for pick-up and return. Search results can be output by the vehicle rental system 116 and presented via the rental company website 112 and/or the rental vehicle application user interface 120 as the case may be.

After the user 104 and the vehicle rental system 116 perform the coordinate vehicle rental process 114 to determine the vehicle type, the date and time for vehicle pick-up, the date and time for vehicle return, the pick-up location, and the return location, the vehicle rental system 116 can create a vehicle rental agreement 124 that specifies the vehicle type, the date and time for vehicle pick-up, the date and time for vehicle drop-off, the pick-up location, the drop-off location, other pertinent information, and any applicable terms and conditions (e.g., liability, insurance, additional fees, and/or the like). The vehicle rental agreement 124 may be provided digitally and signed digitally by the user 104 via the rental company website 112 or the rental vehicle application user interface 120. Alternatively, the vehicle rental agreement 124 may be provided digitally (e.g., via email), printed, and signed physically. The vehicle rental agreement 124 may be signed in-person such as during vehicle pick-up.

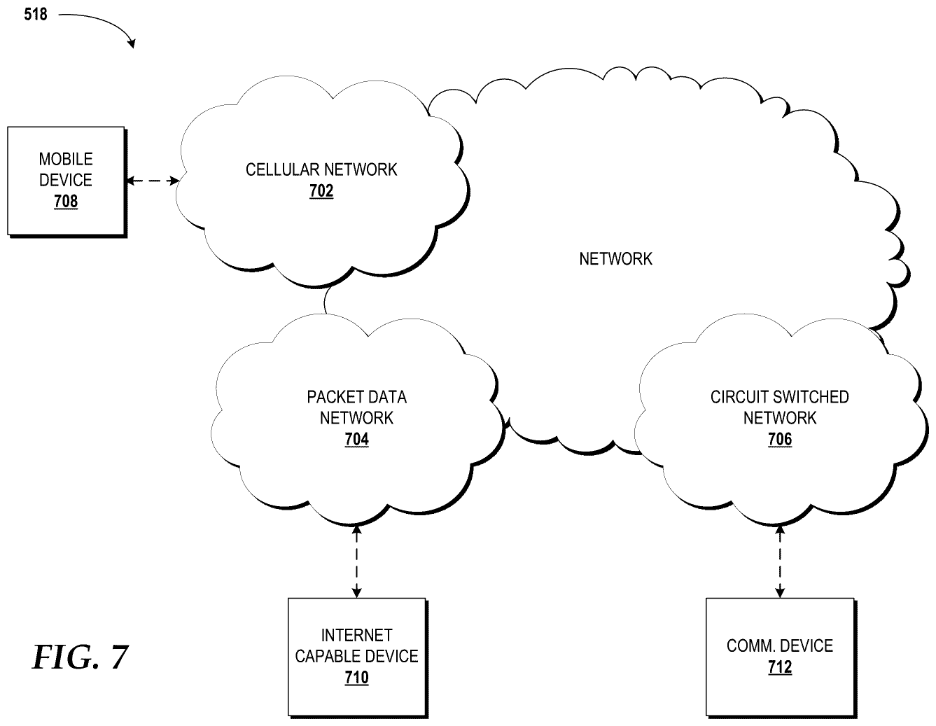

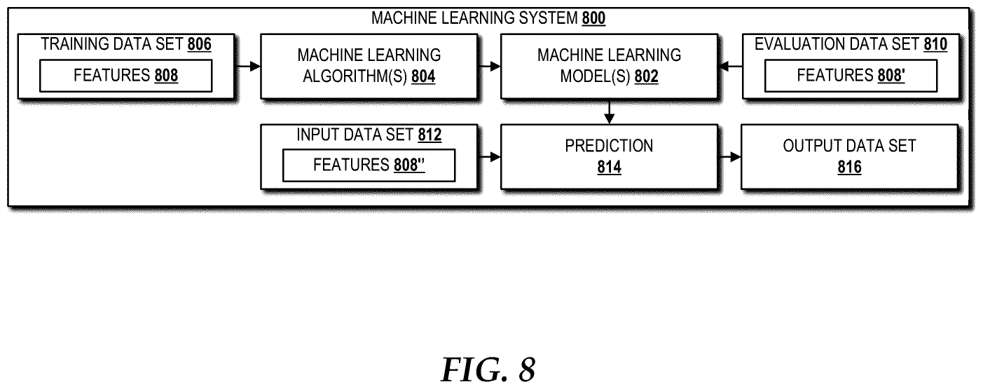

The vehicle rental system 116 can host the rental company website 112 and data, such as from the vehicle rental database 117, that is accessible by the user 104 via the rental vehicle application 118. Alternatively, another system, such as a web server (not shown), can provide this functionality. In the illustrated embodiment, the vehicle rental system 116 includes a vehicle rental machine learning algorithm 126 that can be executed by the vehicle rental system 116, a separate machine learning system 800 (best shown in FIG. 8), or locally on the user device 102 via the rental vehicle application 118. It is contemplated that the machine learning aspects disclosed herein can be performed, at least in part, by the user device 102, by the vehicle rental system 116, by the machine learning system 800, or by a combination thereof. In any case, the device/system that executes, at least in part, the vehicle rental machine learning algorithm 126 can share any machine learning results with the other system(s)/device(s) as needed. Although not shown in FIG. 1, the user device 102, the vehicle rental system 116, the machine learning system 800, and/or other systems/devices mentioned herein can communicate via one or more networks (best shown and described with reference to FIG. 7).

The vehicle rental machine learning algorithm 126 can output what is referred to herein as optimal return location(s) and date(s) that correspond to one or more return locations 128A-128N and the date(s) on which the rental vehicle 106 should be returned to provide the rental company with the highest return on investment (“ROI”) for the rental vehicle 106. This output can be based, at least in part, upon event data 130, user data 132, location data 134, or some combination thereof. The event data 130 can identify any events in proximity to the return locations 128. The proximity can be established by the rental vehicle company (e.g., within X miles of a specific return location 128). The user data 132 can include data about the user 104 and other users/potential users not shown, including rental history, current rental, personal information (e.g., name, address, phone number, email address, and/or the like), schedule (e.g., attending a specific event), and/or the like. The user 104 may opt-in to allowing the rental company to use their user data 132. The location data 134 can identify locations of high foot traffic, popular rental locations, vehicle repair locations (e.g., dealership or third party repair facility), and other location data (e.g., location of the user 104). The user 104 may opt-in to allowing the rental company to obtain and/or track their location. The vehicle rental machine learning algorithm 126 can intake the event data 130, the user data 132, the location data 134, or some combination thereof and can determine which of the return locations 128 would provide the highest ROI for the rental vehicle company for the rental vehicle 106. Although this concept is described in context of a single rental vehicle 106, in a real-world implementation, the vehicle rental machine learning algorithm 126 can be executed for multiple rental vehicles 106 simultaneously as part of an on-going process.

The event data 130, the user data 132, and the location data 134 can be obtained from one or more event data sources, one or more user data sources, and/or one or more location data sources. The data sources may be directly or indirectly associated with the rental company. In some embodiments, the data sources are provided by a third party, such as a mobile telecommunications service provider. Other third parties are contemplated. In some embodiments, the data source(s) can expose one or more application programming interfaces (“APIs”) through which the vehicle rental machine learning algorithm 126 can obtain the event data 130, the user data 132, the location data 134, or some combination thereof.

The vehicle rental system 116 can use the ROI information to determine one or more return options 136 that can be presented to the user 104 via the rental company website 112 and/or the rental vehicle application 118. Alternatively, the rental vehicle application 118 can determine the return options 136 locally, depending on the implementation. For example, based on the latest rental vehicle demand by location, and the expected surge in demand for rental vehicle due to an event (e.g., a concert identified in the event data 130), the vehicle rental system 116 (or rental vehicle application 118) can determine that an earlier return of the rental vehicle 106 should be incentivized to optimize ROI for that rental vehicle 106. In some embodiments, the rental vehicle application 118 can utilize an operating system level notification system to notify the user 104 of the availability of the return option(s) 136. Email, telephone call, text message, and/or other communications can be used to notify the user 104 of the availability of the return option(s) 136.

Each of the return options 136 can identify a return option location 138, a return option date 140, and a return option incentive/credit 142. The return option location 138 can identify one of the return locations 128. The return option date 140 can specify a date (and time if limited) by which the rental vehicle 106 is to be returned in accordance with the selected return option 136. The return option incentive/credit 142 can identify one or more incentives and/or credits to be issued to the user 104 upon acceptance of the corresponding return option 136. The return option incentive/credit 142 may be in the form of future rental credit, future rental upgrade (e.g., small to mid-size vehicle or upgrade to a premium brand), coupons, monetary compensation, a combination thereof, and/or the like. The return option incentive/credit 142 may be determined based on how far the return option location 138 is from the user 104, how high the demand is for the rental vehicle 106, rental rates on the return option date 140, the baseline ROI, other factors, or some combination thereof.

Incentivizing the user 104 to return the rental vehicle 106 early can benefit both the user 1014 and the rental vehicle company. The user 104 can choose to accept one of the return options 136 and utilize a ride share option for their remaining transportation needs if the return option incentive/credit 142 is favorable to them. The user 104 would be under no obligation to return the rental vehicle 106 early unless the terms and conditions of the vehicle rental agreement 124 specify. The vehicle rental agreement 124 may identify a specific return option incentive/credit 142 or a group of potential return option incentives/credits 142 should early return be required instead of optional.

In some instances, the rental vehicle 106 may be in need of repair due to a vehicle issue (e.g., check engine light, tire puncture, or other issue) or may require routine maintenance (e.g., oil change, tire rotation, or other routine maintenance). The rental vehicle company can incentivize the user 104 to have the rental vehicle 106 repaired/maintained at an approved facility (e.g., a dealership or third party mechanic). The incentive/credit in these instances can be similar to the return option incentive/credit 142 described above.

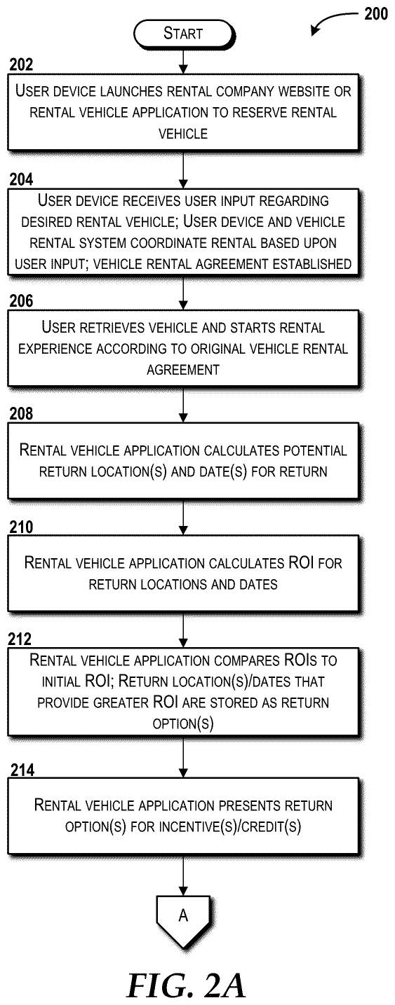

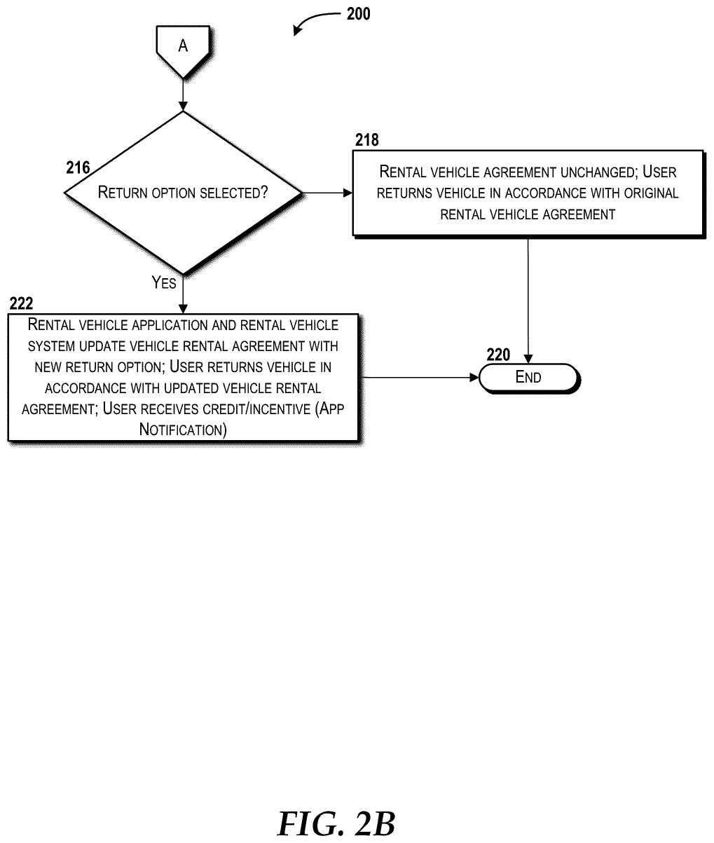

Turning now to FIG. 2A, a flow diagram illustrating aspects of a method 200 for incentivizing rental vehicle return will be described, according to an illustrative embodiments of the concepts and technologies disclosed herein. It should be understood that the operations of the method disclosed herein is not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the method disclosed herein can be ended at any time and need not be performed in its entirety. Some or all operations of the method, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, or a portion thereof, to perform one or more operations, and/or causing the processor to direct other components of the computing system or device to perform one or more of the operations.

For purposes of illustrating and describing the concepts of the present disclosure, operations of the methods disclosed herein are described as being performed alone or in combination via execution of one or more software modules, and/or other software/firmware components described herein. It should be understood that additional and/or alternative devices and/or network nodes can provide the functionality described herein via execution of one or more modules, applications, and/or other software. Thus, the illustrated embodiments are illustrative, and should not be viewed as being limiting in any way.

The method 200 begins and proceeds to operation 202. At operation 202, the user device 102 launches the rental company website 112 or the rental vehicle application 118 to reserve a rental vehicle, such as the rental vehicle 106. From operation 202, the method 200 proceeds to operation 204. At operation 204, the user device 102 receives user input, such as the user input 122, regarding the desired rental vehicle 106. The user device 102 and the vehicle rental system 116 coordinate the rental based upon the user input 122 (shown in FIG. 1 as “coordinate vehicle rental process 114”). After the details of the rental are coordinated, a vehicle rental agreement, such as the vehicle rental agreement 124, can be established between the user 104 and the rental vehicle company. From operation 204, the method 200 proceeds to operation 206. At operation 206, the user 104 retrieves the rental vehicle 106 from the predetermined pick-up location and starts their rental experience in accordance with the vehicle rental agreement 124 (i.e., original vehicle rental agreement).

From operation 206, the method 200 proceeds to operation 208. At operation 208, the rental vehicle application 118 calculates potential return locations 128 and corresponding dates for early return of the rental vehicle 106. As mentioned above, the vehicle rental machine learning algorithm 126 can be executed locally by the user device 102 (e.g., as part of the rental vehicle application 118) or remotely by the vehicle rental system 116. In the latter case, the rental vehicle application 118 can offload the calculation at operation 208 to the vehicle rental system 116. The rental vehicle application 118 obtain rental data about all nearby (configurable value) return locations 128 (e.g., from the vehicle rental database 117). The vehicle rental machine learning algorithm 126 also can obtain any applicable event data 130 (e.g., a local concert) within a specified radius of the return locations 128, as well as any applicable user data 132 and location data 134. Based on this data, the rental vehicle application 118 can calculate the potential return locations 128 and corresponding dates for early return of the rental vehicle 106.

From operation 208, the method 200 proceeds to operation 210. At operation 210, the rental vehicle application 118 can calculate the ROI for the potential return locations 128 and corresponding dates. The ROI can consider the costs associated with the rental vehicle 106, any incentive(s)/credit(s) to be provided to the user 104 for early return of the rental vehicle 106, and potential revenue that can be generated from early return by the user 104 and rental to another user. From operation 210, the method 200 proceeds to operation 212. At operation 212, the rental vehicle application 118 compares the ROIs calculated at operation 210 to the initial ROI should the user 104 continue their rental experience in accordance with the original vehicle rental agreement 124. Also at operation 212, the rental vehicle application 118 stores the return location(s) 128 and corresponding date(s) that provide a greater ROI as the return option(s) 136.

From operation 212, the method 200 proceeds to operation 214. At operation 214, the rental vehicle application 118 presents the return option(s) 136 for specified incentive(s)/credit(s) 142. From operation 214, the method 200 proceeds to operation 216 shown in FIG. 2B. At operation 216, the rental vehicle application 118 determines whether a return option 136 was selected. If not, the method 200 proceeds to operation 218. At operation 218, the vehicle rental agreement 124 is unchanged and the user 104 returns the rental vehicle 106 in accordance with the vehicle rental agreement 124. From operation 218, the method 200 proceeds to operation 220. The method 200 can end at operation 220. Returning to operation 216, if the rental vehicle application 118 determines that a return option 136 was selected, the method 200 proceeds to operation 222. At operation 222, the rental vehicle application 118 and the vehicle rental system 116 correspond to update the vehicle rental agreement 124 with the new return option 136. The user 104 then returns the rental vehicle 106 in accordance with the updated vehicle rental agreement 124. The user 104 also receives the incentive(s)/credit(s) 142 (or a notification thereof for later retrieval). From operation 222, the method 200 proceeds to operation 220. The method 200 can end at operation 220.

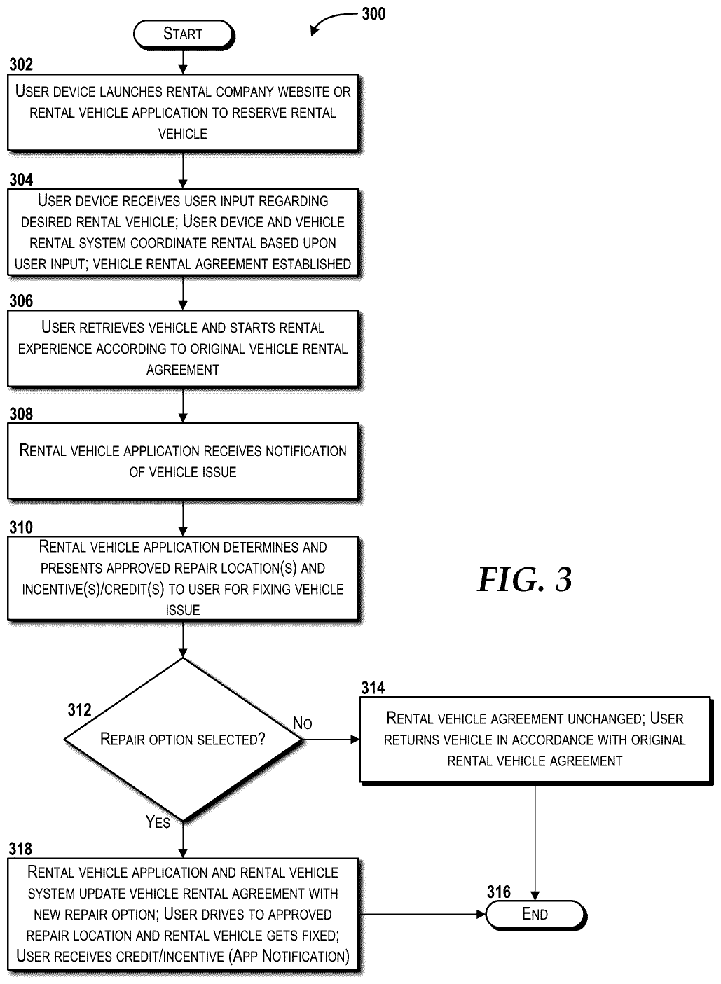

Turning now to FIG. 3, a method 300 for incentivizing rental vehicle repair or maintenance will be described, according to an illustrative embodiment. The method 300 begins and proceeds to operation 302. At operation 302, the user device 102 launches the rental company website 112 or the rental vehicle application 118 to reserve a rental vehicle, such as the rental vehicle 106. From operation 302, the method 300 proceeds to operation 304. At operation 304, the user device 102 receives user input, such as the user input 122, regarding the desired rental vehicle 106. The user device 102 and the vehicle rental system 116 coordinate the rental based upon the user input 122 (shown in FIG. 1 as “coordinate vehicle rental process 114”). After the details of the rental are coordinated, a vehicle rental agreement, such as the vehicle rental agreement 124, can be established between the user 104 and the rental vehicle company. From operation 304, the method 300 proceeds to operation 306. At operation 306, the user 104 retrieves the rental vehicle 106 from the predetermined pick-up location and starts their rental experience in accordance with the vehicle rental agreement 124 (i.e., original vehicle rental agreement).

From operation 306, the method 300 proceeds to operation 308. At operation 308, the rental vehicle application 118 receives a notification of a vehicle issue. The notification can be received directly from the rental vehicle 106. For example, a on-board diagnostics (“OBD”) port can communicate the notification to the rental vehicle application 118 (additional components such as a BLUETOOTH dongle may be required). Alternatively, the user 104 can provide the user input 122 indicating that the rental vehicle 106 has an issue (e.g., tire puncture, loss of power, or some other issue). The vehicle issue alternatively may be maintenance issue, such as a oil change reminder generated by the rental vehicle 106. Other vehicle issues and/or maintenance concerns may be input into the rental vehicle application 118 by the user 104 or another party, such as a representative of the rental company (over the Internet or in-person).

From operation 308, the method 300 proceeds to operation 310. At operation 310, the rental vehicle application 118 determines one or more approved repair locations and any incentive(s)/credit(s) to be provided to the user 104 for fixing the vehicle issue on behalf of the rental company. Also at operation 310, the rental vehicle application 118 presents the approved repair location(s) and any incentive(s)/credit(s) as different selectable options. From operation 310, the method 300 proceeds to operation 312. At operation 312, the rental vehicle application 118 determines whether a repair option was selected. If not, the method 300 proceeds to operation 314. At operation 314, the vehicle rental agreement 124 is unchanged and the user 104 returns the rental vehicle 106 in accordance with the vehicle rental agreement 124. From operation 314, the method 300 proceeds to operation 316. The method 300 can end at operation 316. Returning to operation 312, if the rental vehicle application 118 determines that a repair option was selected, the method 300 proceeds to operation 318. At operation 318, the rental vehicle application 118 and the vehicle rental system 116 correspond to update the vehicle rental agreement 124 with the new repair option. The user 104 then drives the rental vehicle 106 to the approved repair location and the rental vehicle 106 gets fixed in accordance with the updated vehicle rental agreement 124. The user 104 also receives the incentive(s)/credit(s) 142 (or a notification thereof for later retrieval). From operation 318, the method 300 proceeds to operation 316. The method 300 can end at operation 316.

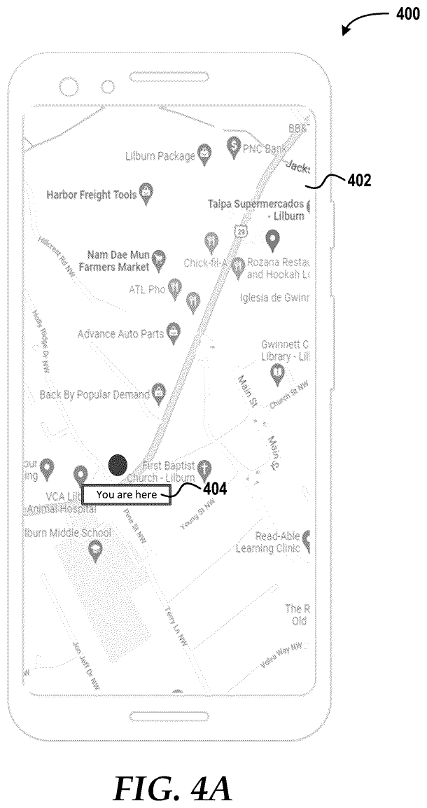

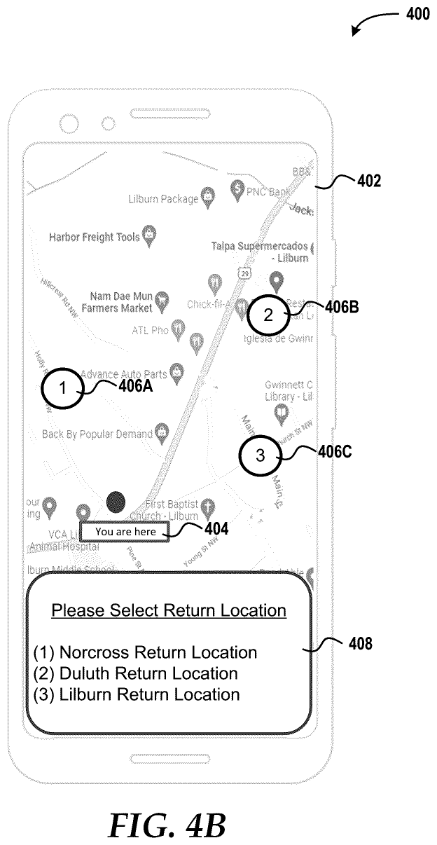

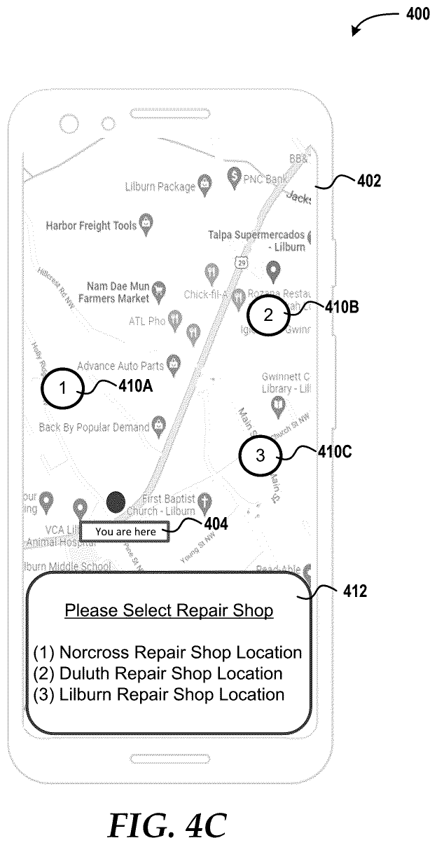

FIGS. 4A-4C are GUI diagrams of exemplary user interfaces for implementing aspects of the concepts and technologies disclosed herein, according to illustrative embodiments. The colors, shapes, fonts, graphics, images, and other design elements of the GUI diagrams are intended merely as examples to aid in explanation of some features disclosed herein. Accordingly, the design of the GUI diagrams should not be construed as being limiting in any way.

Turning first to FIG. 4A, a user device display 400 of the user device 102 is shown. The user device display 400 can present a map 402 with a current location identifier 404 marking the current location of the user 104. Turning to FIG. 4B, the user device display 400 presents a plurality of return location identifiers 406A-406C, each of which corresponds to one of the return locations 128 identified by the vehicle rental system 116 as eligible for early return. A return location prompt 408 is also shown with additional details about the plurality of return location identifiers 406A-406C. Similarly, in FIG. 4C, the user device display 400 presents a plurality of repair shop location identifiers 410A-410C, each of which corresponds to a repair shop location identified by the vehicle rental system 116 as approved to perform vehicle repair(s) and/or routine maintenance on the rental vehicle 106. A repair shop location prompt 412 is also shown with additional details about the plurality of repair shop location identifiers 410A-410C.

Turning now to FIG. 5, a block diagram illustrating a computer system 500 configured provide the functionality described herein in accordance with various embodiments will be described. In some embodiments, the user device 102, the vehicle rental system 116, one or more components of the rental vehicle 106, one or more systems/devices operating on or in communication with a network 518 (detail shown in FIG. 7), and/or other systems/devices disclosed herein can be configured the same as or similar to the computer system 500. It should be understood, however, that the user device 102, the vehicle rental system 116, and/or one or more components of the rental vehicle 106 may include additional functionality or include less functionality than now described.

The computer system 500 includes a processing unit 502, a memory 504, one or more user interface devices 506, one or more input/output (“I/O”) devices 508, and one or more network devices 510, each of which is operatively connected to a system bus 512. The system bus 512 enables bi-directional communication between the processing unit 502, the memory 504, the user interface devices 506, the I/O devices 508, and the network devices 510.

The processing unit 502 might be a standard central processor that performs arithmetic and logical operations, a more specific purpose programmable logic controller (“PLC”), a programmable gate array, or other type of processor known to those skilled in the art and suitable for controlling the operation of the computer system 500. Processing units are generally known, and therefore are not described in further detail herein.

The memory 504 communicates with the processing unit 502 via the system bus 512. In some embodiments, the memory 504 is operatively connected to a memory controller (not shown) that enables communication with the processing unit 502 via the system bus 512. The illustrated memory 504 includes an operating system 514 and one or more program modules 516.

The operating system 514 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OSX, iOS, and/or families of operating systems from APPLE CORPORATION, a member of the ANDROID OS family of operating systems from GOOGLE LLC, the FREEBSD family of operating systems, the SOLARIS family of operating systems from ORACLE CORPORATION, other operating systems, and the like.

The program modules 516 may include various software and/or program modules described herein. In embodiments that the user device 102 utilizes an architecture similar to or the same as the computer system 500, the program modules 516 can include, for example, the web browser application 108 and the rental vehicle application 118. In embodiments that the vehicle rental system 116 utilizes an architecture similar to or the same as the computer system 500, the program modules 516 can include, for example, a website hosting application to host the rental company website 112, a server side application to interact with the rental vehicle application 118 operating client-side on the user device 102, one or more API calls to obtain the event data 130, the user data 132, and/or the location data 134, and/or other program modules for performing operations described herein. In some embodiments, the vehicle rental machine learning algorithm 126 can be provided as one or more of the program modules 516. In some embodiments, multiple implementations of the computer system 500 can be used, wherein each implementation is configured to execute one or more of the program modules 516. The program modules 516 and/or other programs can be embodied in computer-readable media containing instructions that, when executed by the processing unit 502, perform the methods 200, 300 described herein. According to embodiments, the program modules 516 may be embodied in hardware, software, firmware, or any combination thereof. The memory 506 also can be configured to store data described herein.

By way of example, and not limitation, computer-readable media may include any available computer storage media or communication media that can be accessed by the computer system 500. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 500. In the claims, the phrase “computer storage medium,” “computer-readable storage medium,” and variations thereof does not include waves or signals per se and/or communication media, and therefore should be construed as being directed to “non-transitory” media only.

The user interface devices 506 may include one or more devices with which a user accesses the computer system 500. The user interface devices 506 may include, but are not limited to, computers, servers, personal digital assistants, cellular phones, or any suitable computing devices. The I/O devices 508 enable a user to interface with the program modules 516. In one embodiment, the I/O devices 508 are operatively connected to an I/O controller (not shown) that enables communication with the processing unit 502 via the system bus 512. The I/O devices 508 may include one or more input devices, such as, but not limited to, a keyboard, a mouse, a touch-sensitive surface, or an electronic stylus. Further, the I/O devices 508 may include one or more output devices.

The network devices 510 enable the computer system 500 to communicate with one or more networks 518. Examples of the network devices 510 include, but are not limited to, a modem, a radio frequency (“RF”) or infrared (“IR”) or ultraviolet (“UV”) transceiver, a telephonic interface, a bridge, a router, or a network card. The network 518 may include a WLAN, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 518 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 6, an illustrative mobile device 600 and components thereof will be described. In some embodiments, the user device 102 can be configured the same as or similar to the mobile device 600. While connections are not shown between the various components illustrated in FIG. 6, it should be understood that some, none, or all of the components illustrated in FIG. 6 can be configured to interact with one another to carry out various device functions. In some embodiments, the components are arranged so as to communicate via one or more busses (not shown). Thus, it should be understood that FIG. 6 and the following description are intended to provide a general understanding of a suitable environment in which various aspects of embodiments can be implemented, and should not be construed as being limiting in any way.

As illustrated in FIG. 6, the mobile device 600 can include a display 602 for displaying data. According to various embodiments, the display 602 can be configured to display various GUI elements (e.g., as shown in FIGS. 4A-4C), text, images, video, virtual keypads and/or keyboards, messaging data, notification messages, metadata, Internet content, device status, time, date, calendar data, device preferences, map and location data, combinations thereof, and/or the like. The mobile device 600 can also include a processor 604 and a memory or other data storage device (“memory”) 606. The processor 604 can be configured to process data and/or can execute computer-executable instructions stored in the memory 606. The computer-executable instructions executed by the processor 604 can include, for example, an operating system 608, one or more applications 610, other computer-executable instructions stored in the memory 606, or the like. The applications 610 can include, for example, the web browser application 108, the rental vehicle application 118, and the vehicle rental machine learning algorithm 126. In some embodiments, the applications 610 can also include a UI application (not illustrated in FIG. 6).

The UI application can interface with the operating system 608 to facilitate user interaction with functionality and/or data stored at the mobile device 600 and/or stored elsewhere. In some embodiments, the operating system 608 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE LLC, a member of the TIZEN OS family of operating systems from THE LINUX FOUNDATION, and/or other operating systems. These operating systems are merely illustrative of some contemplated operating systems that may be used in accordance with various embodiments of the concepts and technologies described herein and therefore should not be construed as being limiting in any way.

The UI application can be executed by the processor 604 to aid a user in entering/deleting data, entering and setting user IDs and passwords for device access, configuring settings, manipulating content and/or settings, multimode interaction, interacting with other applications 610, and otherwise facilitating user interaction with the operating system 608, the applications 610, and/or other types or instances of data 612 that can be stored at the mobile device 600.

The applications 610, the data 612, and/or portions thereof can be stored in the memory 606 and/or in a firmware 614, and can be executed by the processor 604. The firmware 614 can also store code for execution during device power up and power down operations. It can be appreciated that the firmware 614 can be stored in a volatile or non-volatile data storage device including, but not limited to, the memory 606 and/or a portion thereof.

The mobile device 600 can also include an input/output (“I/O”) interface 616. The I/O interface 616 can be configured to support the input/output of data such as location information, presence status information, user IDs, passwords, and application initiation (start-up) requests. In some embodiments, the I/O interface 616 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 600 can be configured to synchronize with another device to transfer content to and/or from the mobile device 600. In some embodiments, the mobile device 600 can be configured to receive updates to one or more of the applications 610 via the I/O interface 616, though this is not necessarily the case. In some embodiments, the I/O interface 616 accepts I/O devices such as keyboards, keypads, mice, interface tethers, printers, plotters, external storage, touch/multi-touch screens, touch pads, trackballs, joysticks, microphones, remote control devices, displays, wearables, projectors, medical equipment (e.g., stethoscopes, heart monitors, and other health metric monitors), modems, routers, external power sources, docking stations, combinations thereof, and the like. It should be appreciated that the I/O interface 616 may be used for communications between the mobile device 600 and a network device or local device.

The mobile device 600 can also include a communications component 618. The communications component 618 can be configured to interface with the processor 604 to facilitate wired and/or wireless communications with one or more networks, such as the network 518. In some embodiments, the communications component 618 includes a multimode communications subsystem for facilitating communications via the cellular network and one or more other networks.

The communications component 618, in some embodiments, includes one or more transceivers. The one or more transceivers, if included, can be configured to communicate over the same and/or different wireless technology standards with respect to one another. For example, in some embodiments, one or more of the transceivers of the communications component 618 may be configured to communicate using GSM, CDMA CDMAONE, CDMA2000, LTE, and various other 2G, 2.5G, 3G, 4G, 4.5G, 5G, 6G, 7G, and greater generation technology standards. Moreover, the communications component 618 may facilitate communications over various channel access methods (which may or may not be used by the aforementioned standards) including, but not limited to, TDMA, FDMA, CDMA, W-CDMA, OFDMA, SDMA, and the like.

In addition, the communications component 618 may facilitate data communications using GPRS, EDGE, the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, 5G technologies and standards, and various other current and future wireless data access technologies and standards. In the illustrated embodiment, the communications component 618 can include a first transceiver (“TxRx”) 620A that can operate in a first communications mode (e.g., GSM). The communications component 618 can also include an N^{th} transceiver (“TxRx”) 620N that can operate in a second communications mode relative to the first transceiver 620A (e.g., UMTS). While two transceivers 620A-620N (hereinafter collectively and/or generically referred to as “transceivers 620”) are shown in FIG. 6, it should be appreciated that less than two, two, and/or more than two transceivers 620 can be included in the communications component 618.

The communications component 618 can also include an alternative transceiver (“Alt TxRx”) 622 for supporting other types and/or standards of communications. According to various contemplated embodiments, the alternative transceiver 622 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 618 can also facilitate reception from terrestrial radio networks, digital satellite radio networks, internet-based radio service networks, combinations thereof, and the like. The communications component 618 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 600 can also include one or more sensors 624. The sensors 624 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 600 may be provided by an audio I/O component 626. The audio I/O component 626 of the mobile device 600 can include one or more speakers for the output of audio signals, one or more microphones for the collection and/or input of audio signals, and/or other audio input and/or output devices.

The illustrated mobile device 600 can also include a subscriber identity module (“SIM”) system 628. The SIM system 628 can include a universal SIM (“USIM”), a universal integrated circuit card (“UICC”), embedded SIM (“eSIM”), and/or other identity devices. The SIM system 628 can include and/or can be connected to or inserted into an interface such as a slot interface 630. In some embodiments, the slot interface 630 can be configured to accept insertion of other identity cards or modules for accessing various types of networks. Additionally, or alternatively, the slot interface 630 can be configured to accept multiple subscriber identity cards. Additionally, or alternatively, an embedded SIM may be used. Because other devices and/or modules for identifying users and/or the mobile device 600 are contemplated, it should be understood that these embodiments are illustrative, and should not be construed as being limiting in any way.

The mobile device 600 can also include an image capture and processing system 632 (“image system”). The image system 632 can be configured to capture or otherwise obtain photos, videos, and/or other visual information. As such, the image system 632 can include cameras, lenses, charge-coupled devices (“CCDs”), combinations thereof, or the like. The mobile device 600 may also include a video system 634. The video system 634 can be configured to capture, process, record, modify, and/or store video content. Photos and videos obtained using the image system 632 and the video system 634, respectively, may be added as message content to an MMS message, email message, and sent to another device. The video and/or photo content can also be shared with other devices via various types of data transfers via wired and/or wireless communication devices as described herein.

The mobile device 600 can also include one or more location components 636. The location components 636 can be configured to send and/or receive signals to determine a geographic location of the mobile device 600. According to various embodiments, the location components 636 can send and/or receive signals from global positioning system (“GPS”) devices, assisted-GPS (“A-GPS”) devices, WI-FI/WIMAX and/or cellular network triangulation data, combinations thereof, and the like. The location component 636 can also be configured to communicate with the communications component 618 to retrieve triangulation data for determining a location of the mobile device 600. In some embodiments, the location component 636 can interface with cellular network nodes, telephone lines, satellites, location transmitters and/or beacons, wireless network transmitters and receivers, combinations thereof, and the like. In some embodiments, the location component 636 can include and/or can communicate with one or more of the sensors 624 such as a compass, an accelerometer, and/or a gyroscope to determine the orientation of the mobile device 600. Using the location component 636, the mobile device 600 can generate and/or receive data to identify its geographic location, or to transmit data used by other devices to determine the location of the mobile device 600. The location component 636 may include multiple components for determining the location and/or orientation of the mobile device 600.

The illustrated mobile device 600 can also include a power source 638. The power source 638 can include one or more batteries, power supplies, power cells, and/or other power subsystems including alternating current (“AC”) and/or direct current (“DC”) power devices. The power source 638 can also interface with an external power system or charging equipment via a power I/O component 640. Because the mobile device 600 can include additional and/or alternative components, the above embodiment should be understood as being illustrative of one possible operating environment for various embodiments of the concepts and technologies described herein. The described embodiment of the mobile device 600 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, UV, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 600 or other devices or computers described herein, such as the computer system 700 described above with reference to FIG. 7. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 600 in order to store and execute the software also components presented herein. It is contemplated that the mobile device 600 may not include all of the components shown in FIG. 6, may include other components that are not explicitly shown in FIG. 6, or may utilize an architecture completely different than that shown in FIG. 6.

Turning now to FIG. 7, details of the network 518 are illustrated, according to an illustrative embodiment. The network 518 includes a cellular network 702, a packet data network 704, and a circuit switched network 706. The cellular network 702 includes various components such as, but not limited to, base stations, base transceiver stations (“BTSs”), node Bs (“NB s”), eNBs, gNBs, base station controllers (“BSCs”), radio network controllers (“RNCs”), mobile switching centers (“MSCs”), mobility management entities (“MMEs”), serving gateways (“SGWs”), packet data gateways (“PDGs”), evolved PDGs (“ePDGs), AAA servers, home subscriber servers, short message service centers (“SMSCs”), multimedia messaging service centers (“MMSCs”), home location registers (“HLRs”), visitor location registers (“VLRs”), charging platforms, billing platforms, voicemail platforms, GPRS core network components, EPC core network components, future generation core network components, location service nodes, virtualizations thereof, combinations thereof, and/or the like. The cellular network 702 also includes radios and nodes for receiving and transmitting voice, data, and combinations thereof to and from radio transceivers, networks, the packet data network 704, and the circuit switched network 706.

A mobile communications device 708, such as, for example, the user device 102, the mobile device 600, a cellular telephone, a user equipment, a mobile terminal, a PDA, a laptop computer, a handheld computer, and combinations thereof, can be operatively connected to the cellular network 702 and/or the packet data network 704. The mobile communications device 708 can be configured similar to or the same as the mobile device 600 described above with reference to FIG. 6.

The cellular network 702 can be configured as a GSM network and can provide data communications via GPRS and/or EDGE. Additionally, or alternatively, the cellular network 702 can be configured as a 3G UMTS network and can provide data communications via the HSPA protocol family, for example, HSDPA, EUL, and HSPA+. The cellular network 702 also is compatible with mobile communications standards such as LTE, 5G-NR, or the like, as well as evolved and future mobile standards.

The packet data network 704 includes various systems, devices, servers, computers, databases, and other devices in communication with one another, as is generally known. The packet data network 704 also can include routers, switches, and other WI-FI network components. The packet data network 704 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (“POTS”). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable systems/devices 710 such as the user device 102, the vehicle rental system 116, a laptop, a portable device, or another suitable device, can communicate with one or more cellular networks 702, and devices connected thereto, through the packet data network 704. It also should be appreciated that the mobile communications device 708, such as the mobile device 600, can communicate directly with the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710.

Turning now to FIG. 8, a machine learning system 800 capable of implementing aspects of the embodiments disclosed herein will be described. In some embodiments, the vehicle rental system 116 can be configured to utilize machine learning functionality to perform operations described herein. In the illustrated embodiment of FIG. 1, the vehicle rental system 116 and/or the user device 102 can execute the vehicle rental machine learning algorithm 126. Accordingly, the vehicle rental system 116 and/or the user device 102 can be or can include the machine learning system 800. Alternatively, the vehicle rental system 116 and/or the user device 102 may be in communication with the machine learning system 800 via one or more networks, such as the network 518.

The illustrated machine learning system 800 includes one or more machine learning models 802. The machine learning models 802 can include supervised and/or semi-supervised learning models. The machine learning model(s) 802 can be created by the machine learning system 800 based upon one or more machine learning algorithms 804, such as the vehicle rental machine learning algorithm 126. The machine learning algorithm(s) 804 can be or can be based off of any existing, well-known algorithm, any proprietary algorithms, or any future machine learning algorithm. Some example machine learning algorithms 804 include, but are not limited to, gradient descent, linear regression, logistic regression, linear discriminant analysis, classification tree, regression tree, Naive Bayes, K-nearest neighbor, learning vector quantization, support vector machines, and the like. Classification and regression algorithms might find particular applicability to the concepts and technologies disclosed herein. Those skilled in the art will appreciate the applicability of various machine learning algorithms 804 based upon the problem(s) to be solved by machine learning via the machine learning system 800.

The machine learning system 800 can control the creation of the machine learning models 802 via one or more training parameters. In some embodiments, the training parameters are selected modelers at the direction of an enterprise, for example. Alternatively, in some embodiments, the training parameters are automatically selected based upon data provided in one or more training data sets 806. The training parameters can include, for example, a learning rate, a model size, a number of training passes, data shuffling, regularization, and/or other training parameters known to those skilled in the art.

The learning rate is a training parameter defined by a constant value. The learning rate affects the speed at which the machine learning algorithm 804 converges to the optimal weights. The machine learning algorithm 804 can update the weights for every data example included in the training data set 806. The size of an update is controlled by the learning rate. A learning rate that is too high might prevent the machine learning algorithm 804 from converging to the optimal weights. A learning rate that is too low might result in the machine learning algorithm 804 requiring multiple training passes to converge to the optimal weights.

The model size is regulated by the number of input features (“features”) 806 in the training data set 806. A greater the number of features 808 yields a greater number of possible patterns that can be determined from the training data set 806. The model size should be selected to balance the resources (e.g., compute, memory, storage, etc.) needed for training and the predictive power of the resultant machine learning model 802.

The number of training passes indicates the number of training passes that the machine learning algorithm 804 makes over the training data set 806 during the training process. The number of training passes can be adjusted based, for example, on the size of the training data set 806, with larger training data sets being exposed to fewer training passes in consideration of time and/or resource utilization. The effectiveness of the resultant machine learning model 802 can be increased by multiple training passes.

Data shuffling is a training parameter designed to prevent the machine learning algorithm 804 from reaching false optimal weights due to the order in which data contained in the training data set 806 is processed. For example, data provided in rows and columns might be analyzed first row, second row, third row, etc., and thus an optimal weight might be obtained well before a full range of data has been considered. By data shuffling, the data contained in the training data set 806 can be analyzed more thoroughly and mitigate bias in the resultant machine learning model 802.

Regularization is a training parameter that helps to prevent the machine learning model 802 from memorizing training data from the training data set 806. In other words, the machine learning model 802 fits the training data set 806, but the predictive performance of the machine learning model 802 is not acceptable. Regularization helps the machine learning system 800 avoid this overfitting/memorization problem by adjusting extreme weight values of the features 808. For example, a feature that has a small weight value relative to the weight values of the other features in the training data set 806 can be adjusted to zero.

The machine learning system 800 can determine model accuracy after training by using one or more evaluation data sets 810 containing the same features 808′ as the features 808 in the training data set 806. This also prevents the machine learning model 802 from simply memorizing the data contained in the training data set 806. The number of evaluation passes made by the machine learning system 800 can be regulated by a target model accuracy that, when reached, ends the evaluation process and the machine learning model 802 is considered ready for deployment.

After deployment, the machine learning model 802 can perform a prediction operation (“prediction”) 814 with an input data set 812 having the same features 808″ as the features 808 in the training data set 806 and the features 808′ of the evaluation data set 810. The results of the prediction 814 are included in an output data set 816 consisting of predicted data. The machine learning model 802 can perform other operations, such as regression, classification, and others. As such, the example illustrated in FIG. 8 should not be construed as being limiting in any way.

Based on the foregoing, it should be appreciated that concepts and technologies for incentivized rental vehicle return have been disclosed herein. Although the subject matter presented herein has been described in language specific to computer structural features, methodological and transformative acts, specific computing machinery, and computer-readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject disclosure.

1. A user device comprising:
a processor; and
a memory having computer-executable instructions stored thereon that, when executed by the processor, cause the processor to perform operations comprising
calculating a return location and a return date for a rental vehicle, wherein the rental vehicle is subject to an existing vehicle rental agreement between a user and a rental company,
calculating a return on investment for the return location and the return date in consideration of an incentive to be provided to the user,
comparing the return on investment to an initial return on investment based on the existing vehicle rental agreement,
determining that the return on investment is greater than the initial return on investment, and
presenting, to the user, a return option that identifies the return location, the return date, and the incentive.

2. The user device of claim 1, wherein the operations further comprise receiving a selection of the return option that identifies the return location, the return date, and the incentive; and wherein the existing vehicle rental agreement is updated to reflect the selection of the return option, thereby creating an updated vehicle rental agreement between the user and the rental company.

3. The user device of claim 2, wherein the operations further comprise notifying the user of the incentive upon the user satisfying the updated vehicle rental agreement.

4. The user device of claim 2, wherein the incentive comprises a future rental credit, a future rental upgrade, a coupon, or a monetary compensation.

5. The user device of claim 4, wherein the incentive is based, at least in part, upon how far the return location is from a current location of the user, a current demand for the rental vehicle, a rental rate on the return date, and the initial return on investment.

6. The user device of claim 1, wherein calculating the return location and the return date for the rental vehicle comprises utilizing a machine learning algorithm to calculate the return location and the return date for the rental vehicle.

7. The user device of claim 6, wherein utilizing the machine learning algorithm to calculate the return location and the return date for the rental vehicle comprises locally executing the machine learning algorithm to calculate the return location and the return date for the rental vehicle.

8. The user device of claim 6, wherein utilizing the machine learning algorithm to calculate the return location and the return date for the rental vehicle comprises coordinating, with a remote machine learning system, execution of the machine learning algorithm to calculate the return location and the return date for the rental vehicle.

9. A computer-readable storage medium having computer-executable instructions stored thereon that, when executed by a processor of a user device, cause the user device to perform operations comprising:
calculating a return location and a return date for a rental vehicle, wherein the rental vehicle is subject to an existing vehicle rental agreement between a user and a rental company;
calculating a return on investment for the return location and the return date in consideration of an incentive to be provided to the user;
comparing the return on investment to an initial return on investment based on the existing vehicle rental agreement;
determining that the return on investment is greater than the initial return on investment; and
presenting, to the user, a return option that identifies the return location, the return date, and the incentive.

10. The computer-readable storage medium of claim 9, wherein the operations further comprise receiving a selection of the return option that identifies the return location, the return date, and the incentive; and wherein the existing vehicle rental agreement is updated to reflect the selection of the return option, thereby creating an updated vehicle rental agreement between the user and the rental company.

11. The computer-readable storage medium of claim 10, wherein the operations further comprise notifying the user of the incentive upon the user satisfying the updated vehicle rental agreement.

12. The computer-readable storage medium of claim 10, wherein the incentive comprises a future rental credit, a future rental upgrade, a coupon, or a monetary compensation.

13. The computer-readable storage medium of claim 12, wherein the incentive is based, at least in part, upon how far the return location is from a current location of the user, a current demand for the rental vehicle, a rental rate on the return date, and the initial return on investment.

14. The computer-readable storage medium of claim 9, wherein calculating the return location and the return date for the rental vehicle comprises utilizing a machine learning algorithm to calculate the return location and the return date for the rental vehicle.

15. The computer-readable storage medium of claim 14, wherein utilizing the machine learning algorithm to calculate the return location and the return date for the rental vehicle comprises locally executing the machine learning algorithm to calculate the return location and the return date for the rental vehicle.

16. The computer-readable storage medium of claim 14, wherein utilizing the machine learning algorithm to calculate the return location and the return date for the rental vehicle comprises coordinating, with a remote machine learning system, execution of the machine learning algorithm to calculate the return location and the return date for the rental vehicle.

17. A method comprising:
calculating, by a system comprising a processor, a return location and a return date for a rental vehicle, wherein the rental vehicle is subject to an existing vehicle rental agreement between a user and a rental company;
calculating, by the system, a return on investment for the return location and the return date in consideration of an incentive to be provided to the user;
comparing, by the system, the return on investment to an initial return on investment based on the existing vehicle rental agreement;
determining, by the system, that the return on investment is greater than the initial return on investment; and
presenting, by the system, to the user, a return option that identifies the return location, the return date, and the incentive.

18. The method of claim 17, further comprising receiving a selection of the return option that identifies the return location, the return date, and the incentive; and wherein the existing vehicle rental agreement is updated to reflect the selection of the return option, thereby creating an updated vehicle rental agreement between the user and the rental company.

19. The method of claim 18, further comprising notifying the user of the incentive upon the user satisfying the updated vehicle rental agreement.

20. The method of claim 17, wherein calculating the return location and the return date for the rental vehicle comprises utilizing a machine learning algorithm to calculate the return location and the return date for the rental vehicle.
